(19) United States
(12) Patent Application Publication
(10) Pub. No.: US 2026/0094129 A1
(43) Pub. Date: Apr. 2, 2026

(54) INFORMATION OUTPUT APPARATUS, INFORMATION OUTPUT METHOD, AND NON-TRANSITORY STORAGE MEDIUM

(71) Applicant: NEC Corporation, Tokyo (JP)

(72) Inventors: Mamoru Hirota, Tokyo (JP); Takashi Nonaka, Tokyo (JP); Taiga Takahashi, Tokyo (JP); Kentaro Nishida, Tokyo (JP)

(73) Assignee: NEC Corporation, Tokyo (JP)

(21) Appl. No.: 19/333,877

(22) Filed: Sep. 19, 2025

(30) Foreign Application Priority Data
Sep. 30, 2024 (JP) 2024-170105

(51) Int. Cl. G06Q 10/20; G06Q 10/0631

(52) U.S. Cl. CPC G06Q 10/20; G06Q 10/06315

(57) ABSTRACT

An information output device includes a first output unit and a second output unit. The first output unit acquires type specifying information capable of specifying a type of a maintenance target, acquires first work information indicating a first work for obtaining additional information on a state of the maintenance target using the type specifying information, and outputs the first work information to a communication device. The second output unit acquires additional information generated while performing the first work or after performing the first work, acquires second work information indicating a second work to be performed by an owner or a user of the maintenance target to perform maintenance on the maintenance target using the additional information, and outputs the second work information to the communication device.

This application is based upon and claims the benefit of priority from Japanese patent application No. 2024-170105, filed on September 30, 2024, the disclosure of which is incorporated herein in its entirety by reference.

### TECHNICAL FIELD

The present invention relates to an information output device, an information output method, and a program.

### BACKGROUND ART

In a case where devices or facilities need to be maintained, a maintenance expert often deals with it. For example, JP 2020-194436 A discloses a server that performs the following processing. The server first refers to received operation data of a washing and drying machine to obtain a factor of abnormality occurring in an electric device by a factor determination unit, and refers to a notification database in which a notification destination of predetermined information for solving the abnormality is associated with each factor of the abnormality to select the notification destination associated with the factor of the abnormality obtained by the factor determination unit from a plurality of candidates. Then, the server transmits the predetermined information to a terminal of the selected notification destination to notify a person in charge of handling the abnormality of the predetermined information. In the notification database, a terminal of a user of the electric device and a terminal of a maintenance worker in charge of repair of the electric device are registered.

### SUMMARY

In order to properly perform maintenance on a maintenance target, additional information regarding a state of the maintenance target is often required. However, there is a case where an owner or a user of the maintenance target has little knowledge about the maintenance target, and as a result, there is a case where the owner or the user cannot obtain the additional information and cannot perform the maintenance appropriately.

An information output device according to one aspect of the present disclosure includes first output means for acquiring type specifying information capable of specifying a type of a maintenance target, acquiring first work information indicating a first work for obtaining additional information regarding a state of the maintenance target by using the type specifying information, and outputting the first work information to a communication device, and second output means for acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device.

An information output method according to one aspect of the present disclosure causes a computer to perform acquiring type specifying information capable of specifying a type of a maintenance target, acquiring first work information indicating a first work for obtaining additional information regarding a state of the maintenance target by using the type specifying information, and outputting the first work information to a communication device, and acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device.

A program according to one aspect of the present disclosure causes a computer to function as first output means for acquiring type specifying information capable of specifying a type of a maintenance target, acquiring first work information indicating a first work for obtaining additional information regarding a state of the maintenance target by using the type specifying information, and outputting the first work information to a communication device, and second output means for acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device.

According to an example of the present disclosure, an owner or a user of a maintenance target can easily obtain additional information regarding the maintenance target, and as a result, maintenance of the maintenance target can be appropriately performed.

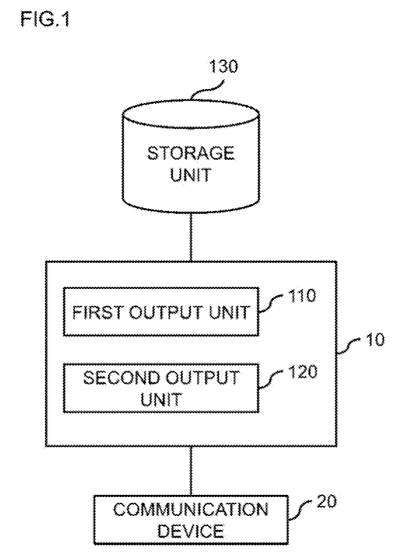

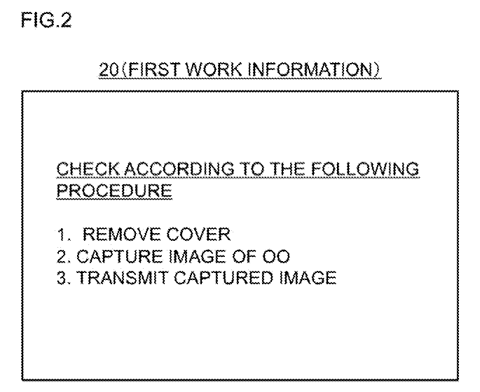

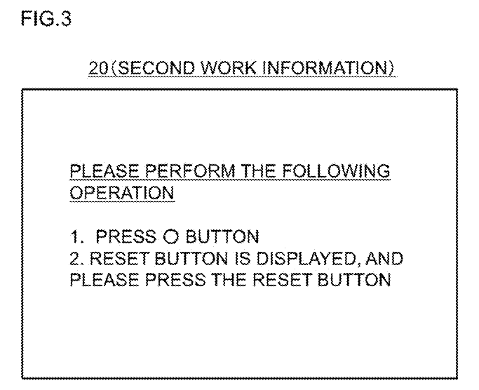

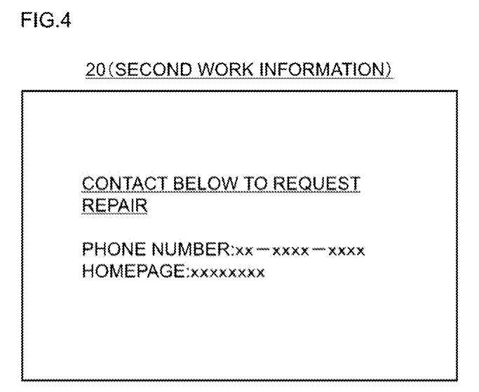

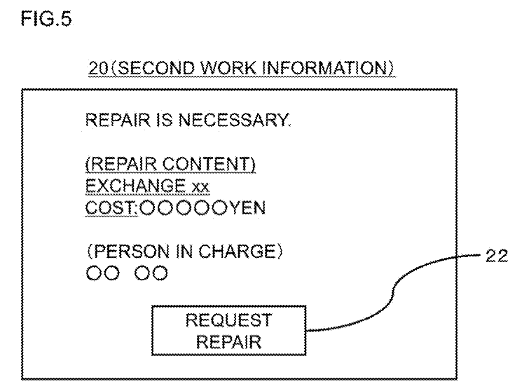

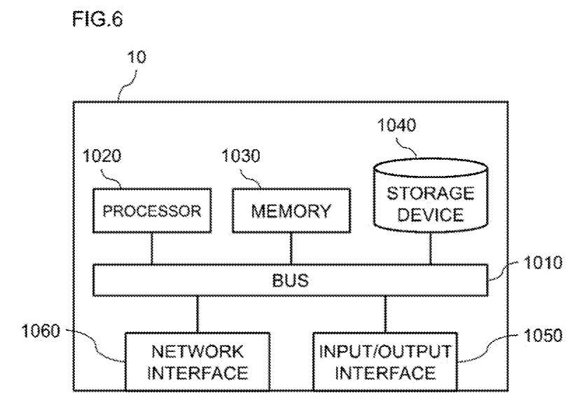

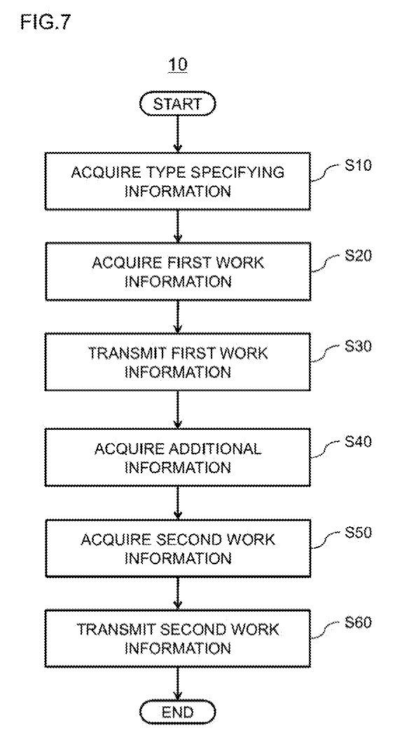

### BRIEF DESCRIPTION OF THE DRAWINGS

[FIG. 1] It is a block diagram illustrating an example of a functional configuration of an information output device according to the present disclosure together with an example of a usage environment of the information output device;

[FIG. 2] It is a diagram illustrating an example of first work information displayed by a communication device;

[FIG. 3] It is a diagram illustrating an example of second work information displayed by the communication device;

[FIG. 4] It is a diagram illustrating an example of the second work information displayed by the communication device;

[FIG. 5] It is a diagram illustrating an example of the second work information displayed by the communication device;

[FIG. 6] It is a diagram illustrating an example of a hardware configuration of the information output device; and

[FIG. 7] It is a flowchart illustrating an example of processing performed by the information output device.

### EXAMPLE EMBODIMENT

Hereinafter, in the present disclosure, the drawings are associated with one or more example embodiments. In all the drawings, similar components are denoted by similar reference signs, and descriptions thereof will be omitted as appropriate.

An information output device 10 is used together with a communication device 20, for example, as illustrated in FIG. 1, in a case where maintenance of a maintenance target is performed. The communication device 20 is operated by, for example, an owner or a user of the maintenance target. That is, the communication device 20 is used by a person who is not specialized in the maintenance of the maintenance target. The communication device 20 may be a fixed communication device, a tablet communication device, or a portable communication device such as a so-called smartphone. In a case where the communication device 20 controls a display, the display may be a head-mounted display. In this case, the communication device 20 itself may be a head-mounted communication device. The communication device 20 preferably includes an imaging device.

The maintenance target is, for example, at least one of the following. ·Electric device. An example of the electric device is at least one of an air conditioner having a temperature control function, a refrigerator, a washing machine, an information processing device such as a personal computer, and a printer. ·Automobile. An automobile includes at least one of a vehicle driven by an internal combustion engine, an electric vehicle, a hybrid vehicle, and a fuel cell vehicle. ·Gas appliance. An example of a gas appliance is at least one of a water heater and a gas stove. ·Water supply equipment used in buildings. For example, the water supply equipment is at least one of a water supply distribution system and a sewerage drainage system.

In a case where maintenance of a maintenance target is required, for example, in a case where a failure occurs in the maintenance target, additional information regarding a state of the maintenance target is often required in order to appropriately perform the maintenance of the maintenance target. The information output device 10 is used in a case where the owner or the user of the maintenance target acquires the additional information.

The additional information is, for example, at least one of the following. The following images are collectively referred to as a first image. ·An image including an error code displayed on a display of a maintenance target or a display on which the error code is displayed ·Appearance image of the maintenance target ·Image of an interior of the maintenance target. For example, in a case where the maintenance target is an automobile, this image may be an image of an instrument panel or a dashboard, or an image of an inside of a hood. ·Measurement result of voltage or the like of a specific part of the maintenance target

The information output device 10 includes a first output unit 110 and a second output unit 120, and can use a storage unit 130. The storage unit 130 stores various types of information used by the information output device 10. The storage unit 130 may be a part of the information output device 10 or may be located outside the information output device 10.

The first output unit 110 acquires type specifying information that can specify a type of the maintenance target, for example, model specifying information that can specify a model of the maintenance target. For example, the first output unit 110 acquires the type specifying information from the communication device 20. Then, the first output unit 110 acquires, by using the type specifying information, first work information indicating a first work for obtaining additional information on a state of the maintenance target. Then, the first output unit 110 outputs the first work information to the communication device 20.

The type specifying information may be text information indicating a model number or a product number of the maintenance target, or may include an image obtained by imaging the maintenance target. Hereinafter, this image is referred to as a first image. The first image may be an image obtained by imaging the appearance of the maintenance target, or may be an image obtained by imaging a region where a model number or a product number of the maintenance target can be specified, for example, at least one of a seal indicating the model number or the product number, a bar code, and a two-dimensional code. Then, the first output unit 110 specifies the model number of the maintenance target by processing the first image.

The first work information includes, for example, information indicating at least one of the following. ·A procedure for removing a part (for example, a cover). For example, in a case where the maintenance target is an automobile, an example of this procedure is how to open a hood. ·Items to be visually confirmed by the owner or the user. For example, a state of an appearance of a specific part, information displayed on a display, a value indicated by a measuring meter, a connection state of a specific connector, and the like.

The storage unit 130 stores the first work information for each type of the maintenance target. Then, the first output unit 110 acquires the first work information associated with the acquired type specifying information from the storage unit 130.

The first output unit 110 may acquire supplementary information indicating a state of the maintenance target together with the type specifying information from the communication device 20, for example. This information is, for example, information indicating a non-operating part of the maintenance target or information (for example, an error code) displayed on a display of the maintenance target, and may be text or an image. Then, the first output unit 110 acquires the first work information using the supplementary information.

For example, the storage unit 130 stores the first work information for each combination of the type specifying information and the supplementary information. Then, the first output unit 110 acquires the acquired first work information associated with the combination of the type specifying information and the supplementary information from the storage unit 130.

The second output unit 120 acquires the additional information generated while performing the first work or after performing the first work from, for example, the communication device 20. Then, the second output unit 120 acquires second work information indicating the second work by using the additional information. The second work is work to be performed by the owner or the user to perform maintenance of the maintenance target. Then, the second output unit 120 outputs the second work information to the communication device 20.

The second work information is stored in the storage unit 130, for example. The second output unit 120 classifies the additional information according to, for example, a predetermined rule. This classification is, for example, to specify a maintenance factor, for example, a failure factor, occurring in the maintenance target. The storage unit 130 stores the second work information for each maintenance target and each classification result. Then, the second output unit 120 acquires the second work information associated with the classification result of the additional information from the storage unit 130.

The second output unit 120 may perform this classification using a machine learning model. In this case, the storage unit 130 may store this machine learning model.

The additional information includes, for example, at least one of the following: ·An image obtained while the first work is performed or after the first work is performed, and capturing at least one of a maintenance target and a person who has performed the first work. Hereinafter, the image will be referred to as a second image. An example of the second image is an image of an inside of the maintenance target. The second image may be a moving image. ·Text information including results visually confirmed by the owner or the user

The second work includes, for example, at least one of the following works. ·Works to be performed on maintenance targets by an owner or a user. In this case, the second work information includes guidance on the second work, for example, information indicating a work procedure. The second work information may include at least one of an image and a moving image, or may include link information for displaying the image and the moving image. ·The second work includes that the owner or the user requests maintenance of the maintenance target to an expert of the maintenance. In this case, the second work information includes information necessary for requesting an expert to perform maintenance. The expert here is, for example, a person who performs maintenance on the maintenance target as a job.

In a case where the second work includes that the owner or the user requests maintenance of the maintenance target to an expert of the maintenance, the second output unit 120 may specify the content of maintenance necessary for the maintenance target using the additional information. In this case, the second output unit 120 specifies the expert using the specified maintenance content, and includes information regarding the expert in the second work information. The information regarding the expert includes, for example, contact information on the expert, but may further include a name of the expert.

The content of the maintenance is stored in the storage unit 130 in association with a classification result of the additional information, for example. Then, the second output unit 120 acquires, from the storage unit 130, information indicating the content of maintenance, for example, information indicating a maintenance factor such as a failure factor.

The storage unit 130 stores information that can specify an expert for each combination of a maintenance target and a maintenance content. The information that can specify the expert includes, for example, contact information on the expert, but may further include at least one of a name of the expert and a responsible area.

Then, the second output unit 120 specifies an expert associated with a combination of the maintenance target and the maintenance content acquired from the storage unit 130 using the information stored in the storage unit 130, and reads out information on the specified expert from the storage unit 130. Then, the second output unit 120 sets the read information as at least a part of the second work information.

In a case where the second work includes that the owner or the user requests maintenance of the maintenance target to an expert of the maintenance, the second output unit 120 may specify the expert using position information regarding the position of the maintenance target and include information regarding the expert in the second work information. Similarly, in this example, the information regarding the expert includes, for example, contact information on the expert, but may further include a name of the expert.

In this example, the storage unit 130 stores information that can specify an expert for each combination of the maintenance target and the maintenance content, and stores information indicating an area in charge of the expert for each expert. Then, the first output unit 110 or the second output unit 120 acquires position information regarding the position of the maintenance target, for example, an address of a place where the maintenance target is located. The granularity of this address may be a city, a ward, a town, or a village, or may be finer. Then, the second output unit 120 specifies an expert whose area of responsibility includes this address.

The second output unit 120 may specify a cost required for the expert to perform maintenance and include the cost in the second work information. The information indicating the cost is stored, for example, in the storage unit 130 for each type of the maintenance target and each maintenance factor. Then, the second output unit 120 specifies the cost using the storage unit 130.

Here, the second output unit 120 may increase or decrease the cost specified using the storage unit 130 using other conditions. In this case, the cost required for maintenance may be set by dynamic pricing. Information on other conditions is stored in the storage unit 130.

The other condition described above is, for example, whether it is in a busy season. In this case, the cost in the busy season increases. The other condition may be the degree of availability of the schedule of the expert. In this case, the cost increases as the vacancy of the schedule of the expert decreases.

FIG. 2 is a diagram illustrating an example of the first work information displayed by the communication device 20. In this example, the first work information indicates a procedure of the first work by text. However, the first work information may indicate this procedure by an image or may include link information for obtaining this image.

FIG. 3 is a diagram illustrating an example of the second work information displayed by the communication device 20. In this example, the second work information indicates, by text, a procedure of work to be performed on the maintenance target by the owner or the user of the maintenance target. However, the second work information may indicate this procedure by an image or may include link information for obtaining this image.

FIG. 4 is a diagram illustrating an example of the second work information displayed by the communication device 20. In this example, the second work information includes information necessary for the owner or the user of the maintenance target to request maintenance from the expert, for example, information indicating contact information such as a telephone number or a link to a homepage.

FIG. 5 is a diagram illustrating an example of the second work information displayed by the communication device 20. In this example, the second work information includes the content of maintenance, a cost required for maintenance, a name of an expert in charge of maintenance, and a button 22 for requesting maintenance. In a case where the owner or the user of the maintenance target selects the button 22, the communication device 20 transmits information necessary for requesting maintenance to the information output device 10. Then, the information output device 10 performs processing for accepting a request for maintenance, for example, displays a screen for final confirmation of the maintenance content. A button for officially requesting maintenance may be also displayed on this screen. In this case, in a case where the owner or the user presses this button, the communication device 20 and the information output device 10 perform processing for officially accepting maintenance.

As illustrated in FIG. 6, for example, the information output device 10 includes a bus 1010, a processor 1020, a memory 1030, a storage device 1040, an input/output interface 1050, and a network interface 1060 as a hardware configuration.

The bus 1010 is a data transmission path for the processor 1020, the memory 1030, the storage device 1040, the input/output interface 1050, and the network interface 1060 to transmit and receive data to and from each other. However, the method for connecting the processor 1020 and the like to each other is not limited to the bus connection.

The processor 1020 is a processor implemented by a central processing unit (CPU), a graphics processing unit (GPU), or the like.

The memory 1030 is a main storage device implemented by a random access memory (RAM) or the like.

The storage device 1040 is an auxiliary storage device implemented by a removable medium such as a hard disk drive (HDD), a solid state drive (SSD), and a memory card, or a read only memory (ROM), and has a recording medium. The recording medium of the storage device 1040 stores a program module that achieves each function (for example, the first output unit 110 and the second output unit 120) of the information output device 10. The processor 1020 implements the functions associated with the program modules by reading and executing the program modules on the memory 1030. The storage device 1040 may further function as the storage unit 130.

The input/output interface 1050 is an interface for connecting the information output device 10 and various input/output devices. For example, the information output device 10 may communicate with the storage unit 130 via the input/output interface 1050.

The network interface 1060 is an interface for connecting the information output device 10 to a network. The network is, for example, a local area network (LAN) or a wide area network (WAN). A method for connecting the network interface 1060 to the network may be a wireless connection or a wired connection. The information output device 10 may communicate with at least one of the communication device 20 and the storage unit 130 via the network interface 1060.

The information output device 10 operates as illustrated in FIG. 7, for example. First, the user of the communication device 20 inputs the type specifying information to the communication device 20. Then, the communication device 20 transmits the type specifying information to the information output device 10. At this time, the communication device 20 may acquire supplementary information indicating a state of the maintenance target and transmit the supplementary information to the information output device 10 together with the type specifying information.

The first output unit 110 of the information output device 10 acquires the type specifying information (step S10), and acquires the first work information associated with the type specifying information (step S20). In a case of acquiring the supplementary information together with the type specifying information, the first output unit 110 acquires the first work information associated with a combination of the type specifying information and the supplementary information. Then, the first output unit 110 transmits the first work information to the communication device 20 (step S30).

Upon acquiring the first work information, the communication device 20 outputs the first work information. An example of this output is display on a display. Then, the owner or the user of the maintenance target performs work according to the first work information, and inputs the additional information to the communication device 20. This input may be performed by capturing an image. The communication device 20 transmits the additional information to the information output device 10.

The second output unit 120 of the information output device 10 acquires the additional information (step S40), acquires the second work information associated with the additional information (step S50), and transmits the second work information to the communication device 20 (step S60).

Upon acquiring the second work information, the communication device 20 outputs the second work information. An example of this output is display on a display. Then, the owner or the user of the maintenance target performs the second work, that is, coping with the maintenance target, with reference to the second work information. The second work is, for example, either of performing maintenance of the maintenance target in accordance with the second work information or requesting maintenance from an expert.

In this manner, the information output device 10 outputs the first work information to the communication device 20 in order to cause the owner or the user of the maintenance target to recognize the first work information. The first work information indicates a first work for obtaining additional information regarding the state of the maintenance target. Therefore, the owner or the user of the maintenance target can easily obtain the additional information.

Upon acquiring the additional information from the communication device 20, the information output device 10 acquires the second work information using the additional information and outputs the second work information to the communication device 20. The second work information indicates the second work to be performed by the owner or the user to perform maintenance of the maintenance target. The second work is, for example, either of performing maintenance of the maintenance target by oneself or requesting maintenance from an expert. Therefore, the owner or the user of the maintenance target can take an appropriate measure regarding the maintenance of the maintenance target.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

While a plurality of steps (processes) is described in order in the plurality of flowcharts used in the descriptions above, the execution order of the steps executed in each example embodiment is not limited to the described order. In each example embodiment, the order of the illustrated steps can be changed as long as the change does not affect the substance of the process.

Some or all of the example embodiments described above may be described as the following Supplementary Notes, but are not limited to the following. 1. An information output device including: first output means for acquiring type specifying information capable of specifying a type of a maintenance target, acquiring first work information indicating a first work for obtaining additional information regarding a state of the maintenance target by using the type specifying information, and outputting the first work information to a communication device; and second output means for acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device. 2. The information output device according to Supplementary Note 1, in which the type specifying information includes a first image capturing the maintenance target. 3. The information output device according to Supplementary Note 1 or 2, in which the additional information is an image obtained while the first work is performed or after the first work is performed, and includes a second image capturing at least one of the maintenance target and the person who has performed the first work. 4. The information output device according to any one of Supplementary Notes 1 to 3, in which the second work includes a work to be performed on the maintenance target by the owner or the user, and the second work information includes guidance on the second work. 5. The information output device according to any one of Supplementary Notes 1 to 3, in which the second work includes that the owner or the user requests maintenance of the maintenance target to an expert of the maintenance, and the second work information includes information necessary for requesting the maintenance to the expert. 6. The information output device according to Supplementary Note 5, in which the second output means specifies a content of maintenance necessary for the maintenance target by using the additional information, and specifies the expert by using the content of the maintenance, and includes information regarding the expert in the second work information. 7. The information output device according to Supplementary Note 5 or 6, in which the second output means specifies the expert by using position information regarding a position of the maintenance target, and includes information regarding the expert in the second work information. 8. The information output device according to any one of Supplementary Notes 5 to 7, in which the second output means specifies a cost required for the expert to perform the maintenance, and includes the cost in the second work information. 9.The information output device according to any one of Supplementary Notes 1 to 8, in which the first output means acquires, as at least a part of the additional information, supplementary information indicating a state of the maintenance target, and acquires the first work information using the supplementary information. 10.The information output device according to any one of Supplementary Notes 1 to 9, in which the communication device is capable of controlling a head-mounted display. 11. An information output method causing a computer to perform: acquiring type specifying information capable of specifying a type of a maintenance target, acquiring first work information indicating a first work for obtaining additional information regarding a state of the maintenance target by using the type specifying information, and outputting the first work information to a communication device; and acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device. 12. A program causing a computer to function as: first output means for acquiring type specifying information capable of specifying a type of a maintenance target, acquiring first work information indicating a first work for obtaining additional information regarding a state of the maintenance target by using the type specifying information, and outputting the first work information to a communication device; and second output means for acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device. 13. A recording medium in which the program according to Supplementary Note 12 is recorded.

Some or all of the configurations described in Supplementary Notes 2 to 10 dependent on the above-described Supplementary Note 1 can be dependent on any of Supplementary Notes 11 to 13 by the same dependency relationship as that of Supplementary Notes 2 to 10. Not only Supplementary Notes 1 and 11 to 13, but also various recording means or systems for recording various pieces of hardware, software, and software can be similarly dependent on some or all of the configurations described as the supplementary notes without departing from the above-described example embodiments.

1. An information output apparatus comprising:
first output means for acquiring type specifying information capable of specifying a type of a maintenance target, acquiring first work information indicating a first work for obtaining additional information regarding a state of the maintenance target by using the type specifying information, and outputting the first work information to a communication device; and
second output means for acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device.

2. The information output apparatus according to claim 1, wherein
the type specifying information comprises a first image capturing the maintenance target.

3. The information output apparatus according to claim 1, wherein
the additional information is an image obtained while the first work is performed or after the first work is performed, and comprises a second image capturing at least one of the maintenance target and the person who has performed the first work.

4. The information output apparatus according to claim 1, wherein
the second work comprises a work to be performed on the maintenance target by the owner or the user, and
the second work information comprises guidance on the second work.

5. The information output apparatus according to claim 1, wherein
the second work comprises that the owner or the user requests maintenance of the maintenance target to an expert of the maintenance, and
the second work information comprises information necessary for requesting the maintenance to the expert.

6. The information output apparatus according to claim 5, wherein
the second output means specifies a content of maintenance necessary for the maintenance target by using the additional information, and
specifies the expert by using the content of the maintenance, and comprises information regarding the expert in the second work information.

7. The information output apparatus according to claim 5, wherein
the second output means specifies the expert by using position information regarding a position of the maintenance target, and comprises information regarding the expert in the second work information.

8. The information output apparatus according to claim 5, wherein
the second output means specifies a cost required for the expert to perform the maintenance, and comprises the cost in the second work information.

9. An information output method causing a computer to perform:
acquiring type specifying information capable of specifying a type of a maintenance target, acquiring first work information indicating a first work for obtaining additional information regarding a state of the maintenance target by using the type specifying information, and outputting the first work information to a communication device; and
acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device.

10. A non-transitory storage medium storing a program causing a computer to function as:
acquiring type specifying information capable of specifying a type of a maintenance target, acquiring first work information indicating a first work for obtaining additional information regarding a state of the maintenance target by using the type specifying information, and outputting the first work information to a communication device; and
acquiring the additional information generated while the first work is performed or after the first work is performed, acquiring second work information indicating a second work to be performed by an owner or a user of the maintenance target to perform maintenance on the maintenance target using the additional information, and outputting the second work information to the communication device.
